(19) United States
(12) Patent Application Publication
(10) Pub. No.: US 2010/0212244 A1
(43) Pub. Date: Aug. 26, 2010

(54) ASSEMBLAGE OF SEALING NAIL

(76) Inventor: BO-ZHANG YU, KAOHSIUNG CITY (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/392,394

(22) Filed: Feb. 25, 2009

(51) Int. Cl. F16B 15/00; E04F 13/04; F16B 43/00

(52) U.S. Cl. 52/363; 411/439

(57) ABSTRACT

The present invention pertains to an assemblage of sealing nail essentially containing a nail, a propeller, and a blocker that is partially extended beyond the propeller. Wherein, the nail would sequentially penetrate the propeller, the blocker, and then a plank. By means of the nail entering the plank, the propeller and the blocker would be simultaneously urged to densely cover up where the nail inserted. Therefore, a preferred sealing efficiency between the nail and the plank is achieved to guarantee a favorable grouting on the plank.

### BACKGROUND OF THE INVENTION

1. Field of the Invention

The present invention relates to an assemblage, in particular to an assemblage of sealing nail.

2. Description of the Related Art

Referring to FIGS. 1 and 2 showing a self-sealing fastener 1 of Anderson, disclosed by U.S. Pat. No. 6,035,595, is nailed to a plank 2 with a tarpaper 21 for a meshed net 3 to be hung thereon to proceed grouting. The conventional invention consists of a sealing member 11 and a nail 12 penetrating the sealing member 11. Wherein, the sealing member 11 includes a case 111 for the nail 12 to insert, a pusher 112 received in the case 111 for the nail 12 to insert, and an caulking unit 113 filled in the case 11 for being pushed by the pusher 112. Moreover, the meshed net 3 is placed between the sealing member 11 and the nail head. The pusher 112 protrudes toward the orientation of the nail head which arranging the pusher 112 within the case 111. The case 111 further has a plurality of ribs 114 externally projecting from the circumference of the case 111, and a passage 115 defined between any two ribs 114. In addition, the ribs 114 are further disposed opposite to where the pusher 112 protrudes.

While in use, the nail 12 is hammered by relevant tools (not shown in the figures) to drill a bore and penetrate the tarpaper 21 on the plank 2, so that the nail 12 could fix the case 111 on the plank 2 in time of the pusher 112 abutting with the nail head, and the space between the nail 12 and the case 111 could provide with a tight and satisfying hang of the meshed net 3 as shown in FIG. 3. During the process of hammering the nail 12, the pusher 112 is gradually urged to forwardly push and compress the caulking unit 113 within the case 111 so as to extrude and spill the caulking unit 113 out of the case 111. Subsequently, when the nail head densely leans against the case 111 and keep imparting the hammering force upon the case 111, the caulking unit 113 would adhere around the nail 12 as well as outwardly scatter to the passage 115 (shown by FIG. 3). As a result, the caulking unit 113 would seal where the nail 12 is nailed or the nailing bore while the nail 12 is completely inserted into the plank 2, so that water would not permeate through the bore into the plank 2 while proceeding with grouting, resulting to a waterproof efficiency.

Although the self-sealing fastener 1 has a certain sealing competence, it still has deficiencies as follows:
1. The caulking unit 113 belongs to chemical products, and the utilization of the conventional nail set 12 has to be proceeded before the expiration of the caulking unit 113 or the expired caulking unit 113 would bring a qualitative change forth, which results in a handicap of spilling the caulking unit 113 out of the case 111 or affects the sealing competence around where the nail 12 is nailed.
2. To forcedly disperse the caulking unit 113 among the passage 115 via the compression of the pusher 112, user has to impart a nailing or hammering force larger than the impeding force generated from the pusher 112 pushing the caulking unit 113 for urging the pusher 112 to push the caulking unit 113 with large endeavor. Accordingly, the operation of inserting the conventional nail 12 inevitably renders the exhaustion to the user and substantially decreases the operating efficiency.
3. As previously mentioned, a larger imparting force is needed to urge the nail 12; however, an improper overlarge imparting force to the nail 12 not only wastes labors but readily incurs the awry insertion of the nail 12. Whereby, the case 111 would be accordingly out of kilter in view of the slanted nail 12, and a gap would be consequently generated between the case 111 and the plank 2 as shown in FIG. 4. As a result, the subsequent sealing efficiency and grouting would be influenced as long as the caulking unit 113 readily comes off owing to the permeation of the construction materials while grouting.
4. The ribs 114 on the case 111 would prick the tarpaper 21 while the nail 12 penetrates the plank 2. Even if the caulking unit 113 in the case 111 could seal the primary nailing bore where the nail 12 is nailed, the sealing scope is still limited; namely, the areas where the ribs 114 pierce the tarpaper 21 are unable to be sealed. As a result, water would in turn permeate the tarpaper 21 through those pierced holes into the plank 2 during grouting, and the waterproof efficiency is not preferably achieved.

### SUMMARY OF THE INVENTION

It is an object of the present invention to provide an assemblage of sealing nail, which facilitates to increase the sealing efficiency between the nail and planking as well as attain a smooth hammering operation.

The present invention in conformity with the assemblage of sealing nail nailed on a plank for a meshed net being hung thereon to proceed with grouting essentially comprises a nail, a propeller for the nail to penetrate, and a blocker embedded into the propeller for the nail to further penetrate. Wherein, the propeller defines an aperture in communicated with an opened chamber thereon for the nail to penetrate. Further, the blocker has an inserting portion set in the chamber and a spreading portion connected with the inserting portion extending beyond the chamber. In this manner, while imparting a force to hammer the nail into the plank, the nail would urge the propeller and the blocker. Therefore, the blocker would be propelled under the pressure of the propeller to densely seal where the nail inserted, conducing to increasing the sealing efficiency between the nail and the plank and ensuring a smooth grouting. In addition to a larger impartation on the nail being no more needed, a swimmingly favorable nailing is also achieved.

The advantages of the present invention over the known prior arts will become more apparent to those of ordinary skilled in the art by reading the following descriptions with the relating drawings.

### BRIEF DESCRIPTION OF THE DRAWINGS

FIG. 1 is a perspective view showing a conventional self-sealing nail;

FIG. 2 is a schematic view showing the conventional self-sealing nail;

FIG. 3 is a schematic view showing the conventional self-sealing nail in normal using;

FIG. 4 is a schematic view showing the conventional self-sealing nail in practical using;

FIG. 5 is an exploded view showing a first preferred embodiment of the present invention;

FIG. 6 is a schematic view showing the first embodiment;

FIG. 7 is a schematic view showing the first embodiment in use;

FIG. 8 is a schematic view showing a second preferred embodiment;

FIG. 9 is a schematic view showing the second embodiment in use;

FIG. 10 is a schematic view showing a third preferred embodiment; and

FIG. 11 is a schematic view showing a fourth preferred embodiment.

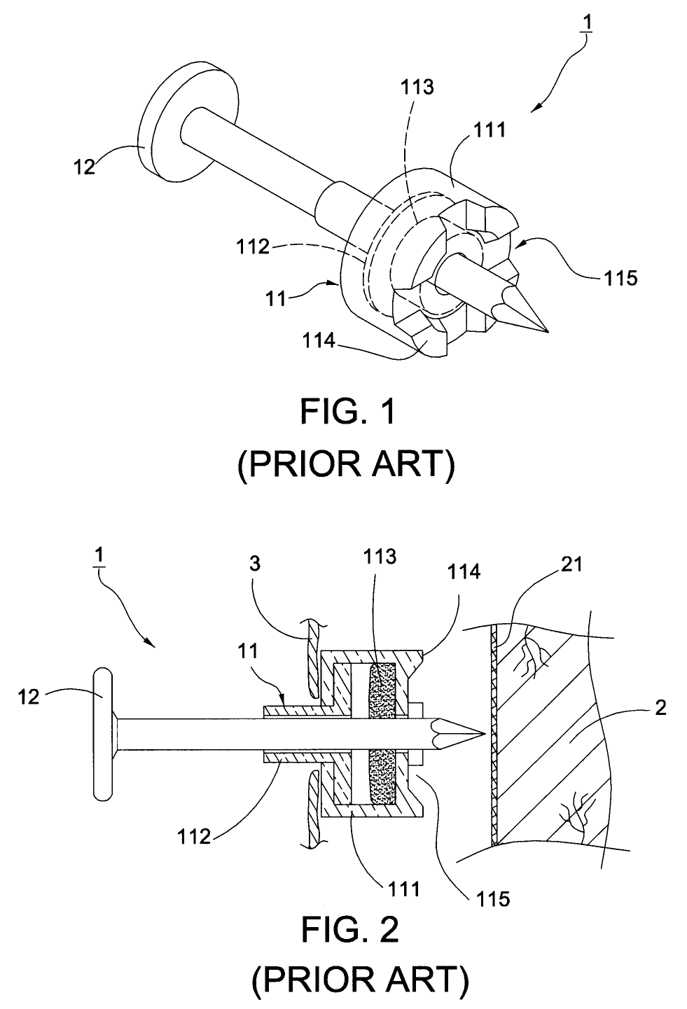

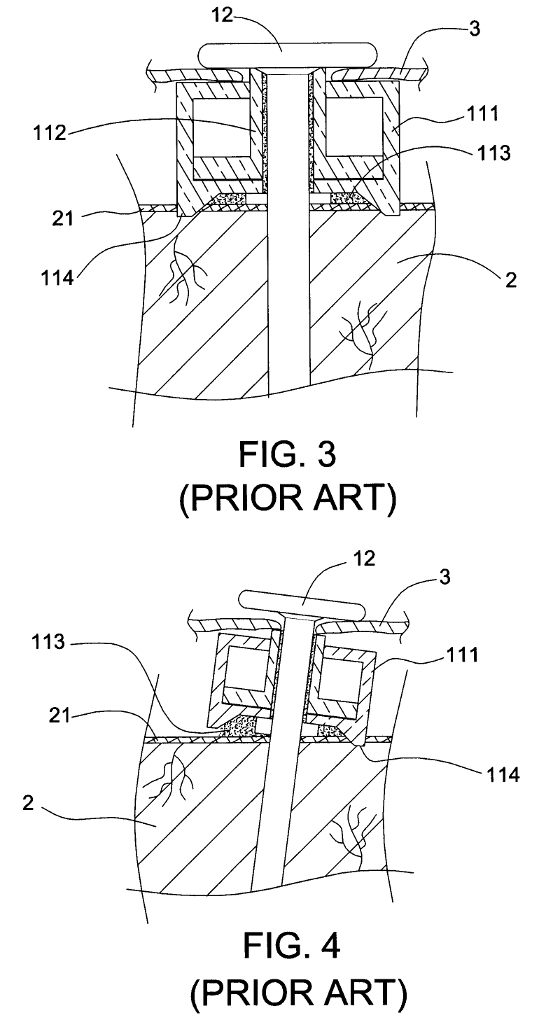

### DETAILED DESCRIPTION OF THE PREFERRED EMBODIMENTS

Before describing in detail, it should note that the like elements are denoted by the similar reference numerals throughout disclosure.

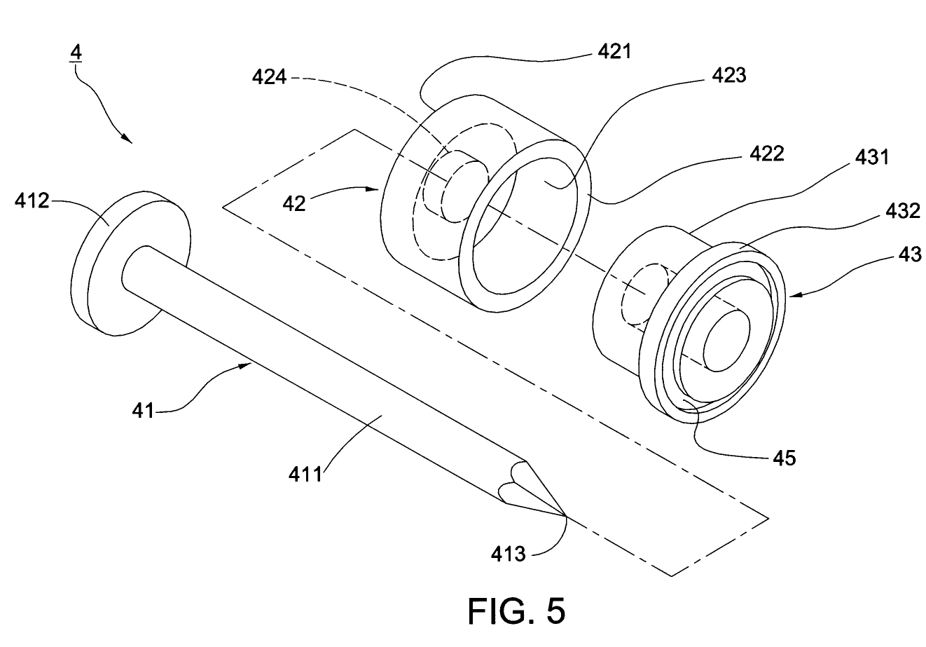

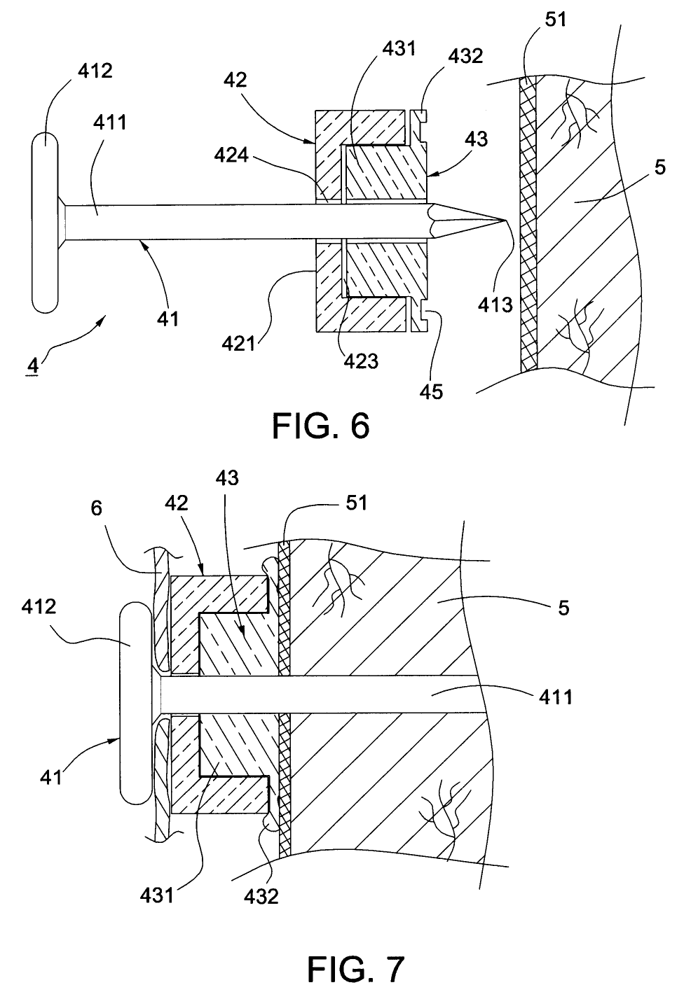

Referring to FIGS. 5 and 6 showing a first preferred embodiment of the present invention, an assemblage of sealing nail 4 is to be nailed into a plank 5 with waterproof membrane 51 for a meshed net 6 (not shown in the Figs) being hung thereon to proceed with grouting. The assemblage of sealing nail 4 essentially comprises a nail 41, a propeller 42 for the nail 41 to penetrate, and a blocker 43 partially set in the propeller 42 for the nail 41 to further penetrate. Wherein, the nail 41 has an axial shank 411, a head 412 disposed on one end of the shank 411, and a tip 413 disposed on the other end of the shank 411. Further, the propeller 42 has a top surface 421, a bottom surface 422 oppositely disposed to the top surface 421, an opened chamber 423 defined from the bottom surface 422 toward the top surface 421, and an aperture 424 defined on the top surface 421 to be intercommunicated with the chamber 423. By this manner, the nail 41 is able to justly go through the aperture 424 and the chamber 423.

Still further, the blocker 43 has an inserting portion 431 implanted in the chamber 423 and a spreading portion 432 connected with the inserting portion 431 projecting out of the chamber 423. Whereby, the spreading portion 432 would densely abut against the bottom surface 422 while inserting the inserting portion 431 into the chamber 423. Moreover, the blocker 43 can be made of any appropriate materials, and herein the blocker 43 is made of a material possessing soft and plastic property in the embodiments of the present invention. Concurrently, both of the inserting and the spreading portions 431 and 432 could be also penetrated by the nail 41. Thus, while hammering the nail 41 into the plank 5, the inserting portion 431 would be propelled by the propeller 42 for enhancing the spreading portion 432 to densely seal where the nail 41 entered. Alternatively, at least one trench 45 can be defined on the surface of the spreading portion 432, and herein the spreading portion 432 merely defines one trench 45 thereon as shown in FIG. 5. Whereby, while the spreading portion 432 tightly covers on the plank 5, the air filled in the trench 45 would be squeezed thereout to improve a preferable and firm sealing efficiency.

Referring to FIGS. 6 and 7 the assemblage of sealing nail 4 is shown in using. In practical, the assembly of the propeller 42 and the blocker 43 is usually arranged at the lower portion of the shank 411, vicinity to the tip 413. The tip 413 of the nail 41 is propped against the plank 5 with the waterproof membrane 51, and the meshed net 6 is hung on the section between the head 412 of the nail 41 and the propeller 42. Whereby, a hammering force is axially imparted to the head 412 of the nail 41 to bring the shank 411 going through the waterproof membrane 51 into the plank 5. A nailing bore is accordingly generated. As the spreading portion 432 contacts with the surface of the plank 5, the spreading portion 432 would force the inserting portion 431 inserted into the propeller 42 while incessantly nailing the nail shank 411, and concurrently the propeller 42 would move forward to the head 412 of the nail 41. When the head 412, the meshed net 6, the propeller 42, and the blocker 43 are tightly fastened on the plank 5, the chamber 423 will be entirely filled up with the inserting portion 431 of the blocker 43, which thence renders the spreading portion 432 to be extremely extruded out of the chamber 423 as plainly depicted shown in FIG. 7, thereby enhancing the spreading portion 432 to concomitantly and securely enclose the nailing bore without damaging the waterproof membrane 51. As a result, the succeeding grouting can be efficiently executed with a favorable watertight competence. Further, since the nail 41 urges the propeller 42 toward the plank 5 when they are in a firm engagement and the plank 5 also in turn props the blocker 43 into the chamber 423 of the propeller 42, a reduced impeding force against the hammering force is attained to save user's labors, hence increasing the working efficiency.

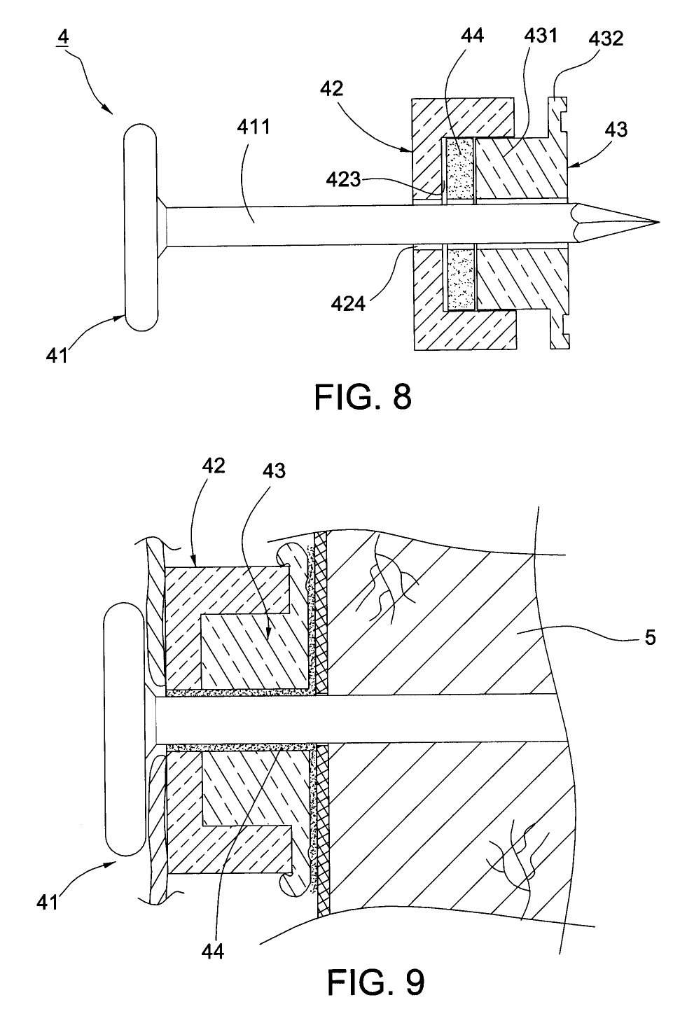

Referring to FIGS. 8 and 9 showing a second preferred embodiment of the assemblage of sealing nail 4 comprises a nail 41, a propeller 42, and a blocker 43. Wherein, the same formation, application, and efficiency of assemblage of sealing nail 4 as those of the first preferred embodiment are herein omitted. Wherein, it is adopted in this embodiment that a caulking unit 44 is filled within the opened chamber 423 and concurrently clogged with the inserting portion 431. Further, the nail 41 is hammered to urge the propeller 42, and the blocker 43 is set against the plank 5 to move toward the chamber 423. In this manner, the caulking unit 44 is coincidently squeezed or compressed by the inserting portion 431 and the propeller 42 to scatteredly fill up any vacant space that is generated between the plank 5 and the assemblage of sealing nail 4, such as the aperture 424, the circumference of the shank 411, and the engaging area of the spreading portion 432 and the plank 5 as shown in dotted areas. Thus, by the supplementary sealing provided by the caulking unit 44, a preferred and solid fastening efficiency of the blocker 43, propeller 42, and the nail 41 is further obtainable.

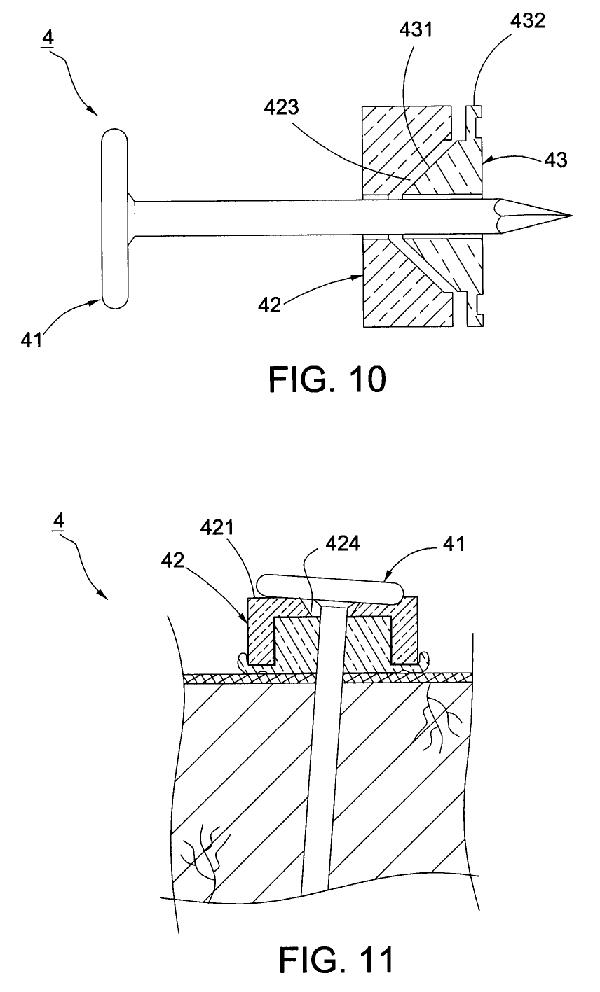

Referring to FIG. 10 showing a third preferred embodiment of the present invention. Herein, the same formation, application, and efficiency of assemblage of sealing nail 4 as those of the first and second preferred embodiments are herein omitted. Wherein, it is adopted in this embodiment that the inserting portion 431 defines a reduced diameter, for instance of a structure tapering from where it connects with the spreading portion 432 to the opened chamber 423, and the opened chamber 423 has a shape of taper correspondently with that of the inserting portion 431. As it should be, the configurations of the inserting portion 431 and the opened chamber 423 are not restricted since the opened chamber 423 is always shaped identical to the inserting portion 431, so that the inserting portion 431 can fully fill up the chamber 423, and the blocker 43 can firmly seal the place where the nail 41 goes through.

Referring to FIGS. 6 and 11 showing a fourth preferred embodiment of the present invention. Herein, the same formation, application, and efficiency of assemblage of sealing nail 4 as those of the first and second preferred embodiments are herein omitted. Wherein, it is adopted in this embodiment that the aperture 424 on the propeller 42 has a first diameter adjacent to the top face 421 larger than a second diameter adjacent to the opened chamber 423 for forming a tapered aperture. In this manner, if an inexperienced user hammers the nail 41 to a slanted situation, the propeller 42 would not be influenced even if the nail 41 is skewed because the tapered aperture 424 provides the nail 41 with an adequate room to adjust. Therefore, a preferable sealing competence is still achievable, and the nail 41 as well as the propeller 42 in this embodiment would more conform to reasonable operation.

To sum up, the present invention takes advantage of the nail going through the propeller and the blocker into the plank to enhance the nail urging the propeller toward the plank and accompany with the plank propping the blocker into the chamber of the propeller. When the nail securely enters into the plank, the chamber is plugged by the inserting portion of the blocker, and the spreading portion partially extended out of the chamber would substantially cover the nailing bore generated while the nail breaks in the plank to increase the sealing capability. Preferably, the increment of the caulking unit within the chamber compressed by the inserting portion also facilitates to more enhance the sealing effect and conduces to the swimmingly grouting.

While we have shown and described the embodiment in accordance with the present invention, it should be clear to those skilled in the art that further embodiments may be made without departing from the scope of the present invention.

I claim:

1. An assemblage of sealing nail nailing to a plank and suspending a meshed net therefrom to proceed with a grouting operation comprising:
a nail having an axial shank, a head disposed on one end of said shank, and a tip disposed on the other end of said shank;
a propeller having a top face, a bottom face disposed oppositely to said top face, an opened chamber defined from said bottom face toward said top face, and an aperture defined on said top face and communicated with said opened chamber, so that said aperture and said opened chamber could be penetrated by said shank of said nail; and
a blocker having an inserting portion embedded into said opened chamber and a spreading portion integrally connected with said inserting portion; wherein, said spreading portion protruding out of said opened chamber and densely abutting with said bottom surface while incorporating said blocker into said propeller; said nail penetrating through said inserting and spreading portions, whereby said propeller propelling said inserting portion and rendering said spreading portion compactly diffusing where said nail penetrating in time of forcedly contacting said propeller with said head.

2. The assemblage as claimed in claim 1, wherein, a caulking unit fills with said opened chamber.

3. The assemblage as claimed in claim 1, wherein, at least one trench is defined on the surface of said spreading portion.

4. The assemblage as claimed in claim 2, wherein, at least one trench is defined on the surface of said spreading portion.

5. The assemblage as claimed in claim 1, wherein, said inserting portion is defined of a reduced diameter shape, and said opened chamber has a shape accords with that of said inserting portion.

6. The assemblage as claimed in claim 2, wherein, said inserting portion is defined of a reduced diameter shape, and said opened chamber has a shape accords with that of said inserting portion.

7. The assemblage as claimed in claim 1, wherein, said aperture has a first diameter adjacent to said top face larger than a second diameter adjacent to said opened chamber for forming a tapered aperture.

8. The assemblage as claimed in claim 2, wherein, said aperture has a first diameter adjacent to said top face larger than a second diameter adjacent to said opened chamber for forming a tapered aperture.
